(19) United States
(12) Patent Application Publication
(10) Pub. No.: US 2014/0122140 A1
(43) Pub. Date: May 1, 2014

(54) ADVANCED MANAGED SERVICE CUSTOMER EDGE ROUTER

(71) Applicant: VERIZON PATENT AND LICENSING INC., Arlington, VA (US)

(72) Inventors: Jan Marcel Rijnders, Leiden (NL); Christopher A. Kimm, Morristown, NJ (US)

(73) Assignee: VERIZON PATENT AND LICENSING INC., Arlington, VA (US)

(21) Appl. No.: 13/664,741

(22) Filed: Oct. 31, 2012

(51) Int. Cl. G06Q 10/06

(52) U.S. Cl. 705/7.13

(57) ABSTRACT

An automated incident management device may receive a message from a customer site, the message indicative of a customer issue with a managed service provided to the customer site by way of a primary network connection. The device may connect to an item of customer equipment by way of a secondary network connection to the customer site; retrieve information from the customer equipment by way of the secondary network connection; attempt a corrective measure with the managed service based on the retrieved information, the corrective measure being determined according to rules that specify corrective measures likely to resolve the trouble ticket; and update a trouble ticket associated with the customer site responsive to the attempted corrective measure. In some examples, the automated incident management device may determine that the customer issue is responsibly of the customer to address.

### BACKGROUND

A customer may choose to outsource management of its information technology (IT) resources to a network service provider. For example, a network service provider may offer managed telecommunications and data services to customers who lack the skill or inclination to manage those services themselves. IT services managed at least in part by a network service provider may be referred to as managed services. To provide managed services to the customer, the network service provider may set up equipment at the customer site, and may implement appropriate settings on the equipment and the network. To maintain managed services, the network service provider may monitor the equipment at the customer site, and may assign personnel to trouble tickets to address any identified issues.

Although the network service provider may perform a number of functions to identify issues and resolve trouble tickets, many trouble tickets may require the services of network service personnel. The costs incurred by the network service provider in addressing these trouble tickets may be substantial. In some cases, the network service provider may request customer involvement in issue troubleshooting, which may be inconvenient or unwelcome by the customer receiving the managed services.

### BRIEF DESCRIPTION OF THE DRAWINGS

FIG. 1 illustrates an exemplary network implementation of a communications system configured to provide managed services to a customer site.

FIG. 2 illustrates an exemplary network implementation of a communications system configured to provide managed services to a customer site including a managed services edge device.

FIG. 3 illustrates an exemplary network implementation of a communications system configured to provide managed services to a customer site including a managed services router.

FIG. 4 illustrates an exemplary network implementation of a communications system configured to provide managed services to a customer site including an alternate managed services edge device.

FIG. 5 illustrates an exemplary process for customer equipment configured to monitor managed services at a customer site.

FIGS. 6A and 6B illustrate an exemplary process for an automated incident management device configured to monitor managed services at customer sites.

FIG. 7 illustrates an exemplary process for an automated incident management device configured to set up customer equipment.

### DETAILED DESCRIPTION

A managed service may involve equipment of a network service provider working in combination with equipment co-located at a customer site. Equipment co-located at the customer site may be owned by the customer or another entity such as the network service provider, but may be referred to herein as customer equipment. While maintenance of aspects of the managed service may fall on the network service provider, the customer may bear some responsibility such as to ensure that the customer equipment is properly stored and powered.

An automated incident management device may be configured to provide for automatic generation of trouble tickets for issues that occur at the customer site. These may include issues that should be addressed by the customer such as loss of power or a pulled cable, or issues that should be addressed by the network service provider such as network configuration errors.

The automated incident management device may be configured to receive a message from an item of customer equipment at a customer site indicating a potential issue with a managed service. The message may be used by the automated incident management device to generate a trouble ticket or to add information to an existing trouble ticket associated with the customer site. To diagnose and resolve the trouble ticket, the automated incident management device may be further configured to connect to an item of customer equipment by way of a secondary network connection to the customer site. The secondary network connection may include, for example, an alternate or backup network connection over a public switched telephone network (PTSN) link or a wireless connection over a cellular data network. The secondary connection may be used to ensure that the customer site maintains network connectivity despite a failure of a primary communications link.

The automated incident management device may be configured to retrieve information from the customer equipment by way of the secondary network connection. Exemplary information may include a status of a power source configured to power the item of customer equipment data from a temperature sensor configured to provide temperature information for the environment in which the customer equipment is placed, and log data from devices at the customer site (e.g., router logs).

The automated incident management device may be further configured to attempt a corrective measure based on the retrieved information. For instance, the automated incident management device may be configured to provide for the remote rebooting of equipment at the customer site. The corrective measures may be performed according to rules that specify corrective measures likely to resolve the trouble ticket. As an example, the rules may specify that if an item of equipment is determined to have an issue, then that item of equipment (and potentially additional items of equipment) may be rebooted or otherwise reset. As another example, the rules may specify corrective measures to be performed that are likely to resolve the trouble ticket based on prior history, such as, that if a trouble ticket presents as being similar to a historical trouble ticket, then the rules may determine to apply corrective measures similar to those that addressed the historical trouble ticket. The automated incident management device may also be configured to update the trouble ticket associated with the customer site responsive to the attempted corrective measure.

In some examples, the automated incident management device may be configured to periodically check a status of the item of customer equipment to determine whether the customer equipment is experiencing an issue. For example, the automated incident management device may generate a message if an item of customer equipment (e.g., a router) cannot be reached for a predetermined duration. As another example, the automated incident management device may receive a message from customer equipment upon loss of primary power or network connectivity. As yet a further example, the automated incident management device may analyze information retrieved from the customer equipment, such as router log files, to determine that one or more devices at the customer site are no longer functioning properly.

In some examples, either message may be sufficient to generate a trouble ticket. As another approach, the automated incident management device may be further configured to correlate messages received from the customer equipment with the periodic polled status of the customer equipment, and to create a trouble ticket associated with the customer site when both the automated incident management device and the customer site both indicate the presence of an issue.

The automated incident management device may be further configured to ensure that only those trouble tickets within the network service provider's area of responsibility are assigned to network engineers for further assessment. Trouble tickets that are determined to be the responsibility of the customer may instead be identified to the customer for the customer to correct. For instance, the automated incident management device may be configured to determine that a power source down message was received from the customer site, and to update the trouble ticket to indicate that the trouble ticket is the result of a power issue that is the responsibly of the customer to repair, not the network service provider.

The secondary network connection to the automated incident management device may be configured to facilitate additional functionality in relation to the managed services. For instance, the automated incident management device may be configured to initiate a backup of data at the customer site by way of the secondary network connection, responsive to receipt of a message indicative of a customer issue with the managed service. The data may include configuration or log data from devices at the customer site (e.g., router logs). The backup data may also include a backup of customer data available over the WAN.

As another example of additional managed services functionality provided by way of the secondary network connection, the automated incident management device may be further configured to allow for the remote setup and configuration of the customer equipment. For example, a service provider may provide customer equipment to a customer for placement at the customer site. When installed, the customer equipment may be auto-discovered by the automated incident management device, allowing for a registration process to be triggered. Identification of the customer equipment may be based on a hardware token or other value made available by the customer equipment. In some cases the automated incident management device may be further configured to confirm that the customer equipment belongs to the customer network wherein it is being installed, such as according to the network location of the customer equipment. The automated incident management device may further be configured to provide configuration information to the customer equipment, perform turn-up testing on the customer equipment upon receipt of the configuration information, and if successful, enabling the monitoring of the customer equipment for issues once configured.

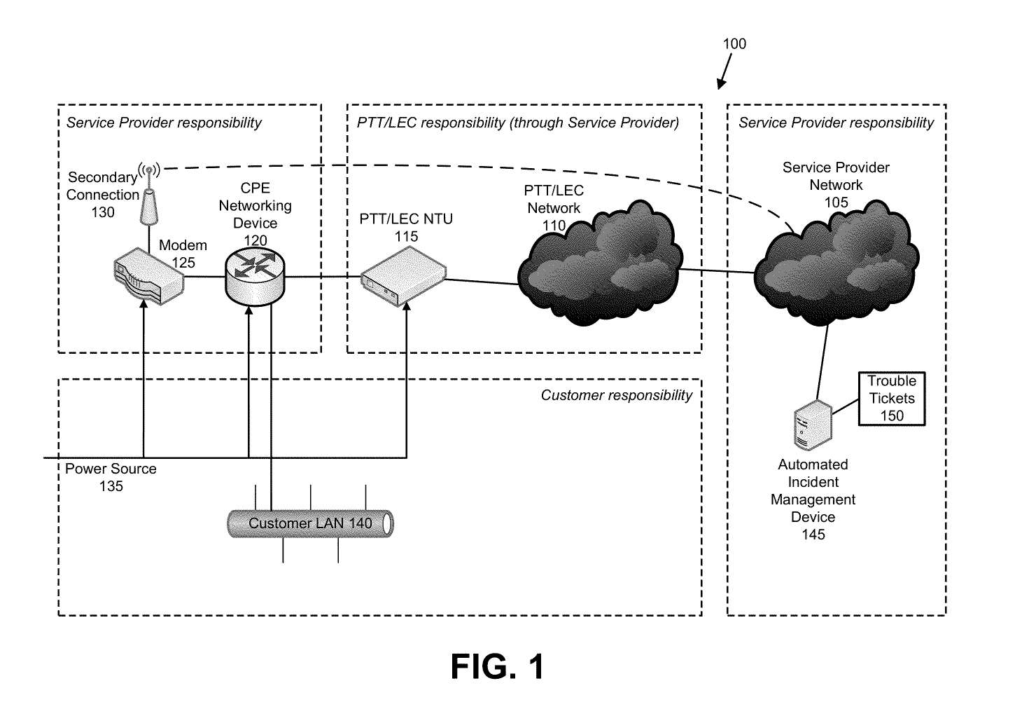

FIG. 1 illustrates an exemplary network implementation of a communications system 100 configured to provide managed services to a customer site. The system 100 may include a network service provider (NSP) network 105 and a PTT/LEC network 110 in communication with the NSP network 105. The system 100 may further include devices installed at a customer site, such as a PTT/LEC network terminating unit (NTU) 115, a customer-premises equipment (CPE) networking device 120 and a modem 125. These devices may be referred to as customer equipment, and may be powered by a power source 135 provided by the customer. The modem 125 may also be connected to a secondary network connection 130 providing additional functionality. The system 100 may further include a customer local area network (LAN) 140 taking advantage of the managed services being provided to the customer site. The system may also include an automated incident management device 145 in communication with the customer equipment at the customer site and configured to store trouble tickets 150 for the system 100. System 100 may take many different forms and include multiple and/or alternate components and facilities. While an exemplary system 100 is shown in FIG. 1, the exemplary components illustrated of the system 100 are not intended to be limiting. Indeed, additional or alternative components and/or implementations may be used.

The NSP network 105 may be configured to transport data between the customer site and other locations on the NSP network 105. The NSP network 105 may provide communications services, including packet-switched network services (e.g., Internet access, VoIP communication services) and circuit-switched network services (e.g., public switched telephone network (PSTN) services) to devices connected to the NSP network 105. Exemplary NSP networks 105 may include the PSTN, a VoIP network, a cellular telephone network, a fiber optic network, and a cable television network. To facilitate communications, communications devices on the NSP network 105 may be associated with unique device identifiers being used to indicate, reference, or selectively connect to the identified device on the NSP network 105. Exemplary device identifiers may include telephone numbers, mobile device numbers (MDNs), common language location identifier (CLLI) codes, internes protocol (IP) addresses, input strings, and universal resource identifiers (URIs). In some cases, the NSP network 105 may be implemented as multiprotocol label switching (MPLS) network. A MPLS NSP network 105 may be configured to route data between sites, such as the customer site, according to path labels associated with the data, rather than by performing the routing according to other mechanisms such as routing lookup tables.

The PTT/LEC network 110 may be a relatively local communications network configured to connect to the NSP network 105 and provide communications services to customer sites by way of the NSP network 105. In some cases, the PTT/LEC network 110 may be provided by a local network service provider providing services to a geographical area including the customer site, while in other cases the PTT/LEC network 110 may be provided by a competing local exchange carrier leasing from the local provider and reselling the communications services.

The PTT/LEC NTU 115 may be configured to terminate a local access circuit which the network service provider may order and provide via the PTT/LEC network 110. The PTT/LEC NTU 115 may accordingly provide a hand-off from the network service provider to the customer site device or devices. In some cases, the PTT/LEC NTU 115 may be owned by the PTT/LEC. However, due to location of the PTT/LEC NTU 115 at the customer site, power for the PTT/LEC NTU 115 may be provided by and be the responsibility of the customer. A large variety of NTU devices may be available on the market and deployed in PTT/LEC networks 110. Lacking a standard regarding the control of these devices, resetting a PTT/LEC NTU 115 may be achieved by the interruption of the power input to the PTT/LEC NTU 115. Some PTT/LEC networks 110 use line-powered PTT/LEC NTUs 115, so in such cases interruption of the communication line may be performed to force a reset of the PTT/LEC NTU 115. In other cases, a messaging or other protocol may be utilized to reset the PTT/LEC NTU 115.

The CPE networking device 120 may be configured to connect to the PTT/LEC NTU 115 at the customer site to provide the managed network services, and to selectively forward data between the NSP network 105 and the devices located at the customer site. The CPE networking device 120 may accordingly be used to access, receive, and use data transmitted over the NSP network 105, including configuration information associated with network services. The CPE networking device 120 may be capable of using network management protocols to communicate with other network devices over the NSP network 105. The CPE networking device 120 may include one or more devices configured to provide a connection by way of the NSP network 105. Exemplary CPE networking devices 120 may include modems, broadband network terminations, servers, switches, network interface cards, premises routers, routing gateways, and the like. As with the PTT/LEC NTU 115, power for the CPE networking device 120 may be provided by and be the responsibility of the customer.

The modem 125 may be configured to be in communication with the NSP network 105 by way of the PTT/LEC network 110. In some cases, the modem 125 may be provided or owned by the network service provider, while in other cases the customer may acquire and use the customer's own equipment.

In addition to the connection to the NSP network 105, the modem 125 may also be connected to a secondary communications network by way of a secondary network connection 130. Exemplary secondary network connections 130 may include a PSTN connection through a PSTN phone line (e.g., customer or NSP owned) or a wireless connection through a cellular mobile access network. The modem 125 may utilize the secondary network connection 130 to provide a secondary access mechanism for telemetry or configuration purposes. For example, the secondary modem line may connect to a console port of the CPE networking device 120. The console port provides a higher privilege level to configure the CPE networking device 120, as compared to a reduced access level that may be available when accessing the CPE networking device 120 via the PTT/LEC NTU 115. In some cases, the modem 125 may utilize the secondary network connection 130 (or another secondary network connection 130) to provide communication services to the customer site when the primary PTT/LEC network 110 is unavailable. In some cases, the secondary network connection 130 may be the responsibility of the PTT/LEC, while in other cases, the secondary network connection 130 may be provided or handled by a different provider of networking services.

The power source 135 may include a source of electric power provided by the customer to one or more of the PTT/LEC NTU 115, CPE networking device 120, modem 125, and customer LAN 140. In many cases, the terms of service for the managed services subscribed to by the customer specify that the customer should have an uninterruptible power supply (UPS) unit at the customer site. However, customers may omit this added item of equipment, which may cause interruptions to power provided to the devices at the customer site, and thereby cause outages and trouble tickets 150 to be created.

The customer LAN 140 may include one or more customer devices under the control of the customer and taking advantage of the managed services. For example, computers, tablets, servers, VoIP phones, and other devices may take advantage of the managed services provided by way of the service provider via the service provider network.

The automated incident management device 145 may be configured to facilitate the monitoring of the equipment located at the customer site that is used for the provisioning of the managed services to the customer. For example, the automated incident management device 145 may periodically retrieve the status of the CPE networking device 120 located at the customer site to verify the proper operation of the CPE networking device 120.

The automated incident management device 145 may be configured to maintain trouble tickets 150 associated with the plurality of customer sites. Each trouble ticket 150 may be associated with an identifier, such as an identifier of a CPE networking device 120 or of another device at the customer site having an issue, an identifier of the user associated with the customer site, or an identifier of the managed services account associated with the customer site. Trouble tickets 150 may further include additional information, such as a time at which an incident occurred or was reported, and any additional information available about the potential repair. Trouble tickets 150 may also be associated with status indicators indicative of the status of the trouble ticket 150. For instance, a trouble ticket 150 may be associated with an unassigned status when it is created. The trouble ticket 150 may be assigned a network service provider working status when it is assigned to support personnel. The trouble ticket 150 may be assigned a customer time status when it is associated with an issue that requires action on the part of the customer of the managed service. The trouble ticket 150 may be assigned to a completed or resolved status when the issue has been fully addressed.

The automated incident management device 145 may be further configured to automatically generate a trouble ticket 150 if the customer equipment cannot be reached for a certain duration or when a message is received from the customer equipment. The automated incident management device 145 may be further configured to notify the customer when a trouble ticket 150 is generated.

The automated incident management device 145 may be further configured to perform corrective measures to resolve the trouble ticket 150. For instance, the automated incident management device may be configured to provide for the remote rebooting of equipment at the customer site. The corrective measures may be performed according to rules that specify which corrective measures are likely to resolve the trouble ticket 150. For example, the rules may specify that if an item of equipment is determined to be having an issue, then that item of equipment may be rebooted. The rules may further specify that an item of equipment related to the item of equipment determined to be having an issue should also be rebooted. For example, if a CPE networking device 120 is determined to be having an issue and is rebooted, then the rules may specify that an associated modem 125 connected to the CPE networking device 120 should also be rebooted. In some cases, the rules may specify corrective measures to be performed that are likely to resolve the trouble ticket 150 based on prior history, such as that if a trouble ticket 150 presents as being similar to a historical trouble ticket 150, then the rules may determine to apply corrective measures similar to those that addressed the historical trouble ticket 150. In yet other cases, the rules may specify corrective measures that include rebooting devices from the item of equipment determined to be having an issue upstream to the connection to the network (e.g., the PTT/LEC network 110), and/or rebooting devices from the item of equipment determined to be having an issue downstream to the devices connected to the customer LAN 140.

The automated incident management device 145 may also be configured to update the trouble ticket associated with the customer site responsive to the attempted corrective measure. Despite these functions, at least a portion of the trouble tickets 150 may need to be worked by repair engineers of the network service provider. Exemplary trouble tickets 150 may include trouble tickets 150 automatically generated based upon loss of primary power or network connectivity of devices at the customer site.

The automated incident management device 145 may be further configured to facilitate the remote setup and configuration of the customer equipment via the secondary network connection 130. For example, the automated incident management device 145 may be configured to connect to the customer equipment via the secondary network connection 130 to provide configuration information to the customer equipment. The customer equipment may be auto-discovered by the automated incident management device 145, allowing for a registration process to be triggered. Identification of the customer equipment may be based on a hardware token or other value made available by the customer equipment. The automated incident management device 145 may be further configured to confirm that the customer equipment belongs to the customer network wherein it is being installed. For instance, the automated incident management device 145 may be configured to verify the network location of the customer equipment with information relating to which customer equipment should be installed as what sites. Moreover, for turn-up testing of a local access portion of a network once the configuration of the customer equipment is performed, one typically would need to establish a loopback on the access circuit through the PTT/LEC network 110, which may cause a temporary loss of access to the customer equipment through that connection. Despite this loss of connectivity, the automated incident management device 145 may maintain connectivity and remote management access with the customer equipment using the secondary network connection 130. Once the customer equipment is setup, it may then be monitored by the automated incident management device 145.

For ease of explanation, the trouble ticket functionality and configuration functionality are discussed herein as being handled by the automated incident management device 145. However, in other examples, different aspects of the functionality of the automated incident management device 145 may be performed by different devices and systems. As one example, the system 100 may include separate devices or subsystems for automating issues and for automating configuration.

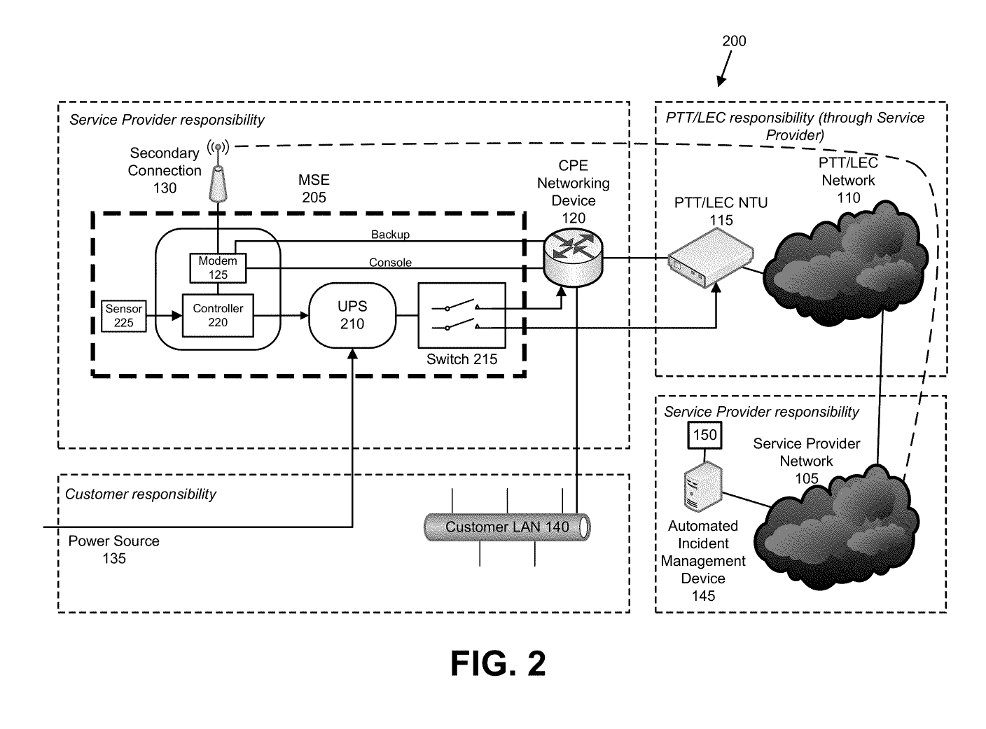

FIG. 2 illustrates an exemplary network implementation of a communications system 200 configured to provide managed services to a customer site including a managed services edge (MSE) device 205. The MSE device 205 may be included as part of an installation on a customer site of hardware configured to support a managed service, in combination with other hardware such as the CPE networking device 120 and the PTT/LEC NTU 115 discussed in detail above. More specifically, the communications system 200 may include a NSP network 105 in communication with a PTT/LEC network 110, which is in turn in communication with a PTT/LEC NTU 115.

The MSE device 205 may integrate the functionality of the modem 125 discussed above with respect to the communications system 100. For example, the integrated modem 125 of the MSE device 205 may be configured to decode communications received over the NSP network 105 as well as to encode communications for transport over the NSP network 105. The integrated modem 125 may be further configured to utilize a secondary network connection 130 to provide telemetry or configuration information, or in some cases remote access to the CPE networking device 120 when the PTT/LEC network 110 or PTT/LEC NTU 115 is unavailable. The MSE device 205 may also integrate additional functionality, such as the customer LAN 140. In such a case, the customer LAN 140 may be part of a managed service offering, where the service extends out to the LAN switches or even to the customer devices connected to the customer LAN 140. Moreover, one or more secondary network connection 130 may be implemented to remotely manage these additional customer devices.

The MSE device 205 may further incorporate a controller CPU 220 configured to facilitate additional control and functionality in relation to the modem 125. As an example, the controller CPU 220 may be configured to allow the MSE device 205 to provide an integrated network failover feature by way of the service provider or the secondary network connection 130. The remote failover feature may be initiated, for example, upon a loss of power or primary network connectivity by the MSE device 205. For instance, the failover feature may include performing a copy of configuration (and log-file) information of the CPE networking device 120 over a communication channel back to the automated incident management device 145. This copy may be accomplished over the connection through the PTT/LEC network 110 or over a secondary network connection 130. As another possibility, the failover feature may perform a copy of customer data stored on devices of the customer LAN 140. This copy may be performed, for example, over the secondary network connection 130 in case the primary connection via the PTT/LEC NTU 115 and PTT/LEC network 110 has failed.

Moreover, the MSE device 205 may be configured to receive data from one or more sensors 225, such as an environmental sensor 225 configured to provide environmental information to the MSE device 205, such as temperature and humidity, as some examples.

As opposed to the communications system 100, in the system 200, the MSE device 205 may be configured to receive power from the power source 135, and to distribute the received power to other devices at the customer site. For example, the MSE device 205 may provide power to one or more of the PTT/LEC NTU 115 and the CPE networking device 120. The MSE device 205 may further include one or more switches 215 configured to selectively provide the power from the power source 135 to the other devices at the customer site according to control by the controller CPU 220.

The MSE device 205 may further include additional functionality, such UPS 210 functionality. The UPS 210 may be configured to maintain charge from the power source 135, and also to allow the MSE device 205 to continue to provide power to the other devices at the customer site despite a loss of power from the power source 135. Equipment such as the PTT/LEC NTU 115, the CPE networking device 120, and the modem 125 may be powered by the UPS 210, while the UPS 210 may be charged by the power source 135. If the power source 135 loses power, charge stored by the UPS 210 may be sufficient to continue to power the devices for a period of time. In some examples, upon loss of power from the power source 135, the MSE device 205 may be further configured to alert the automated incident management device 145 of the loss of power.

The MSE device 205 may be configured to reboot, reset, or power cycle devices at the customer site. For instance, the MSE device 205 may be configured to send a message to a device to cause the device to re-initialize its software or configuration. In other cases, such as for devices that lack such reset functionality, the MSE device 205 may be configured to utilize switches 215 to allow the MSE device 205 to selectively withdraw power from devices at the customer site. Through use of reboot messages or the switches 215, the MSE device 205 may be further configured to remotely reset devices connected to the MSE device 205 (such as, for example, the PTT/LEC NTU 115 and the CPE networking device 120), without the need for any on-site customer interaction.

In addition to putting the equipment into a known state, an additional aspect of performing a reboot/power cycle of the PTT/LEC NTU 115 is that it may aid in confirming if the cabling between the PTT/LEC NTU 115 and the CPE networking device 120 is in place and working. For instance, there may be a signaling protocol utilized between the PTT/LEC NTU 115 and the CPE networking device 120, for example, Ethernet settings may be negotiated between the devices. Upon reboot of the PTT/LEC NTU 115, the PTT/LEC NTU 115 may then start to renegotiate the protocol and may send alarm or status indications to the CPE networking device 120 to indicate that the connection protocol is up or down. If this type of information is not received by the CPE networking device 120 after rebooting the PTT/LEC NTU 115, then this could indicate that the cabling between the PTT/LEC NTU 115 and CPE networking device 120 may be faulty or incorrectly connected. This type of information may accordingly allow the automated incident management device 145 to use predefined rules to assess the incident and take corrective measures likely to resolve the incident.

Accordingly, the MSE device 205 may be configured to reduce the need for customer interaction and to allow for time to notify the customer and the managed services provider that local on-site power has been lost due to the additional capacity of the UPS 210. Moreover, the automated incident management device 145 may be configured to avoid assigning resources to incidents caused by local power interruptions, which may be the customer's responsibility.

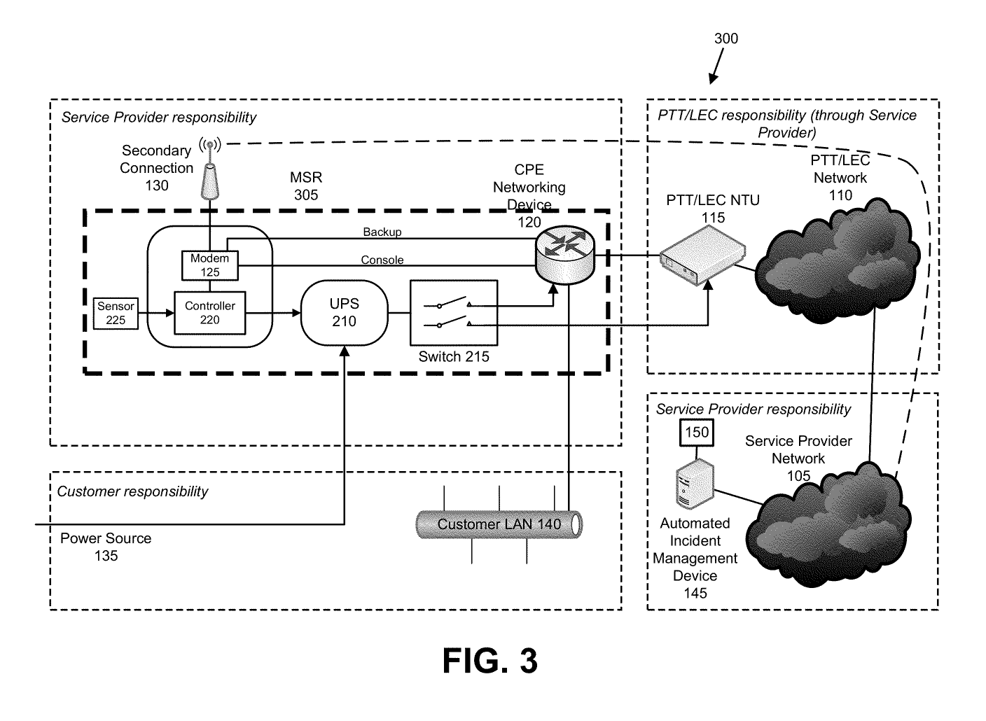

FIG. 3 illustrates an exemplary network implementation of a communications system 300 configured to provide managed services to a customer site including a managed services router (MSR) device 305. The MSR device 305 may integrate the functionality of the MSE device 205 and the CPE networking device 120 discussed above with respect to the communications systems 100 and 200. As compared to having separate MSE device 205 and CPE networking devices 120, the MSR device 305 may integrate the CPE networking device 120 and therefore reduce a number of external physical interfaces, which may have a positive result on the overall system availability by reducing the number of cables and connectors that may fail.

In some examples, the MSR device 305 may be implemented using low-power computer components, such as laptop CPU and battery components. Use of such components may reduce engineering efforts as laptop components are designed to operate on battery (DC) power. Use of such components may also offer flexibility, as portable motherboards may offer variety in input/output connections or networking interfaces.

Moreover, by inclusion of the CPE networking device 120 into the MSR device 305, the UPS 210 functionality may be simplified and optimized. For example, the CPE networking device 120 may operate at a DC voltage in the range of 3-20 volts, where in order to power the CPE networking device 120 from AC, a power supply is required to convert the power source 135 into a low volt DC. For an integrated router function in the MSR device 305, a direct switched DC feed from the UPS 210 may be used to avoid relatively lossy power conversions, such as a DC-AC conversion from the UPS 210 battery to supply power to the CPE networking device 120 followed by an AC-DC power conversion by the CPE networking device 120.

Further, in case of the AC input failing, the MSR device 305 may be configured to switch to a power save mode, in which power intensive processes may be disabled or otherwise adjusted to increase UPS 210 battery life. For example, the power save mode may be configured to maintain power to support the secondary network connection 130 until UPS 210 depletion, to ensure a maximum duration of remote management, control, and remote backup.

In some cases, the battery of the UPS 210 may be accessible and user-replaceable, for example, similar to how a laptop battery may be removable. Because battery lifetime may be limited, ease of access and ease of replacement of the UPS 210 battery by on-site staff or network service provider field engineers may be a further advantage of the MSR device 305 design.

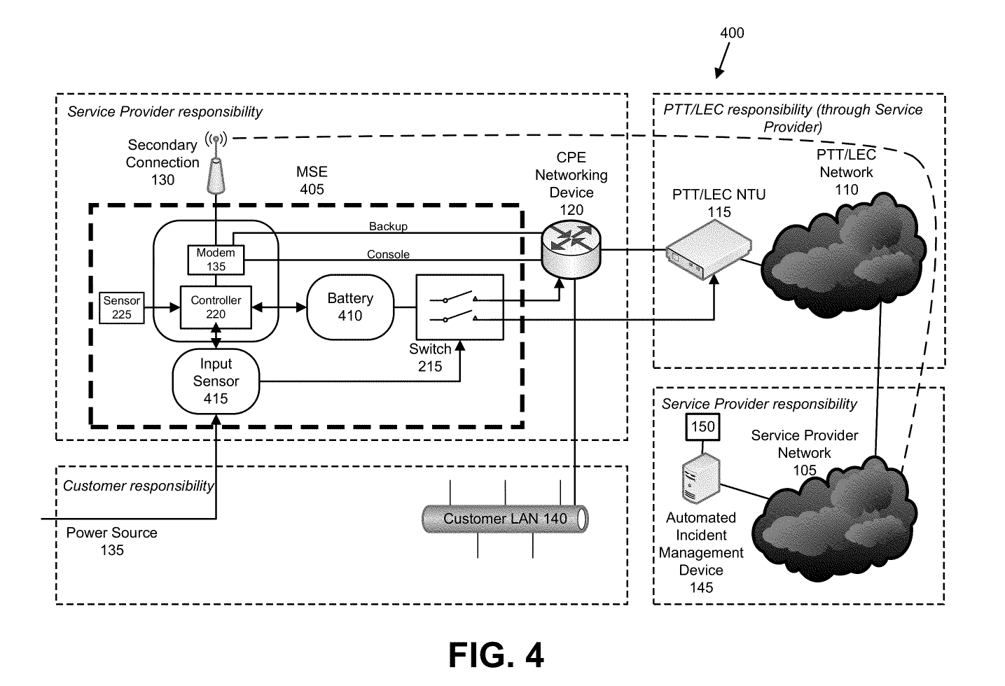

FIG. 4 illustrates an exemplary network implementation of a communications system 400 configured to provide managed services to a customer site including an alternate MSE device 405. Similar to the MSR device 205, The MSR device 405 may integrate functionality such as the modem 125, controller CPU 220, and switch 215 as discussed above with respect to the communications systems 100 and 200.

The MSE device 405 may be configured to notify the automated incident management device 145 of issues with the power source 135. For example, the controller CPU 220 may be configured to monitor the power source 135 and notify the automated incident management device 145 in case the power source 135 becomes unavailable. This function may be achieved by utilizing a battery 410 configured to provide power to the modem 125 and controller CPU 220, instead of or in addition to the UPS 210. While not illustrated, the battery 410 functionality may similarly be implemented into an MSR, such as the MSR device 305 discussed above with respect to communication system 300.

The MSE device 405 may further be configured to notify the automated incident management device 145 of network connectivity issues. For example, the controller CPU 220 may be configured to monitor the connection to the service provider via the CPE networking device 120, and if a network outage is detected, the controller CPU 220 may be configured to provide a notification to the automated incident management device 145 by way of a secondary network connection 130. The automated incident management device 145 system may also be configured to monitor the CPE networking device 120 in parallel, and generate a router down message if CPE networking device 120 becomes unreachable.

In some examples, either a message generated by the MSE device 405 or a message generated by the automated incident management device 145 may be sufficient to cause the automated incident management device 145 to trigger certain actions. In other examples, the automated incident management device 145 may wait to receive a message from the MSE device 405 and also correlate the message with an identified issue determined according to the remote monitoring of the customer site. For instance, upon both the MSE device 405 and the automated incident management device 145 identifying a CPE networking device 120 issue with a power source 135, the automated incident management device 145 may move a trouble ticket 150 associated with the customer site to a status indicative of the issue being one for the customer to address. Or, upon both the MSE device 405 and the automated incident management device 145 identifying a loss of connectivity with no corresponding loss of power, the automated incident management device 145 may move the trouble ticket 150 to a working state and may assign a network engineer to work on the trouble ticket 150.

Moreover, the MSE device 405 may be configured to reset or reboot one or more of the CPE networking device 120 or PTT/LEC NTU 115 upon receiving a remote reboot command, such as from the automated incident management device 145. The reboot may be performed by the MSE device 405 withdrawing power from the CPE networking device 120 or PTT/LEC NTU 115 by the controller CPU 220 using the switches 215 to disconnect and reconnect the power source 135 to the CPE networking device 120 or PTT/LEC NTU 115.

It should be noted that the MSE device 205, MSR device 305, MSE device 405 are only exemplary devices, and variations on the MSE and MSR devices are possible. As an example, the MSE device 205, MSR device 305, or MSE device 405 may be further modified to include WLAN controller functionality to further reduce the customer responsibility. This additional inclusion may also again reduce a number of cables and subsystems (e.g., a separate WLAN controller as separate device). As another example, the MSE device 205, MSR device 305, or MSE device 405 may be further modified to include a WLAN controller and also a LAN switch, making a combined unit where a customer may have direct LAN access (wired or wireless) to the managed device.

In general, computing systems and/or devices, such as the MSE device 205, MSR device 305, MSE device 405, CPE networking device 120 or PTT/LEC NTU 115 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Computing devices may generally include computer-executable instructions that may be executable by one or more processors. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computing device). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, such as the storage of trouble tickets 150, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. For example, aspects of the operations performed by the automated incident management device 145 may be implemented by an application software program executable by an automated incident management device 145. In some example, the application software product may be provided as software that when executed by a processor of the automated incident management device 145 provides the operations described herein. Alternatively, the application software product may be provided as hardware or firmware, or combinations of software, hardware and/or firmware.

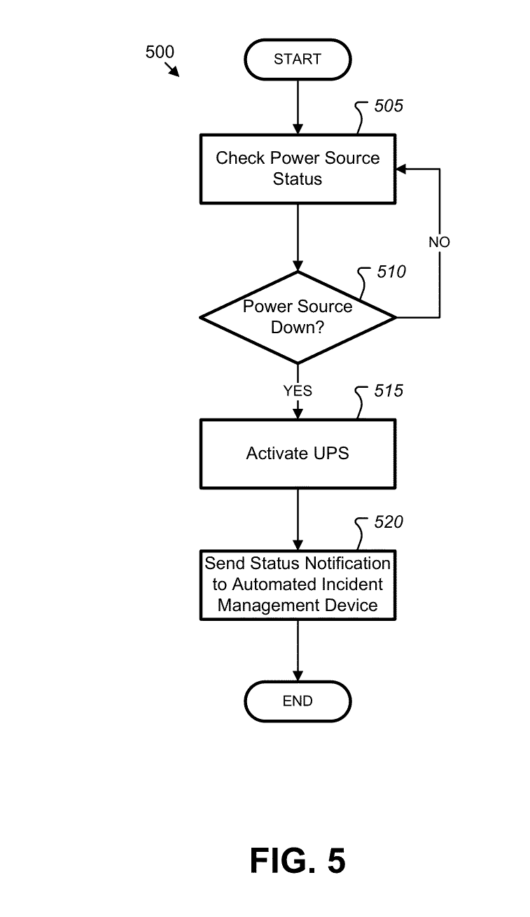

FIG. 5 illustrates an exemplary process 500 for customer equipment configured to monitor managed services at a customer site. The process 500 may be performed by various devices, such as by a MSE device 205, MSR device 305, or MSE device 405 in communication with an automated incident management device 145.

In block 505, the customer equipment checks the status of the power source 135. For example, the customer equipment may be connected to the power source 135, and may determine whether the power source 135 is presently providing power.

In decision point 510, the customer equipment determines whether the power source 135 is down. For example, if the customer equipment determines that the power source 135 is of a lower or higher voltage than specified, or is not providing power at all, then the customer equipment may determines that the power source 135 is down. If the power source 135 is up, control passes to block 505. If the power source 135 is down, control passes to block 515.

In block 515, the UPS 210 becomes activated to power the customer equipment. For example, the UPS 210 may continue to provide power to the other devices at the customer site despite a loss of power from the power source 135.

In block 520, the customer equipment sends a status notification to an automated incident management device 145. For example, if the primary network connection is still usable, and if power may still be supplied to the customer equipment (e.g., via a UPS 210), the customer equipment may send a message to the automated incident management device 145 by way of a PTT/LEC NTU 115, PTT/LEC network 110, and NSP network 105. As another example, the customer equipment may send the message to the automated incident management device 145 by way of a secondary network connection 130, such as over a PTSN link or wirelessly over a cellular data network. After block 520, the process 500 ends.

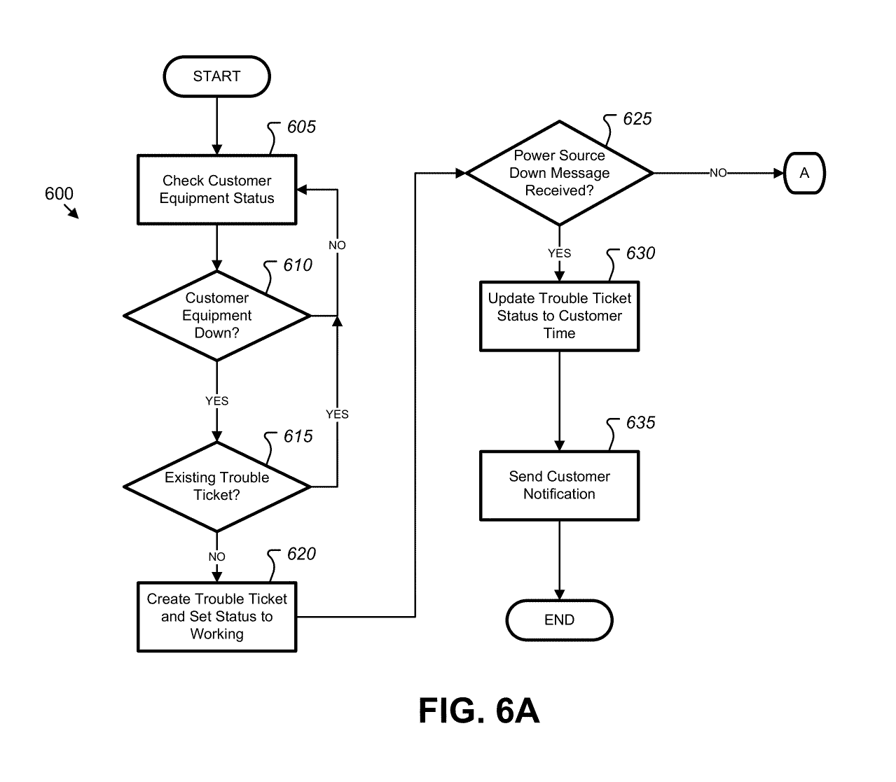

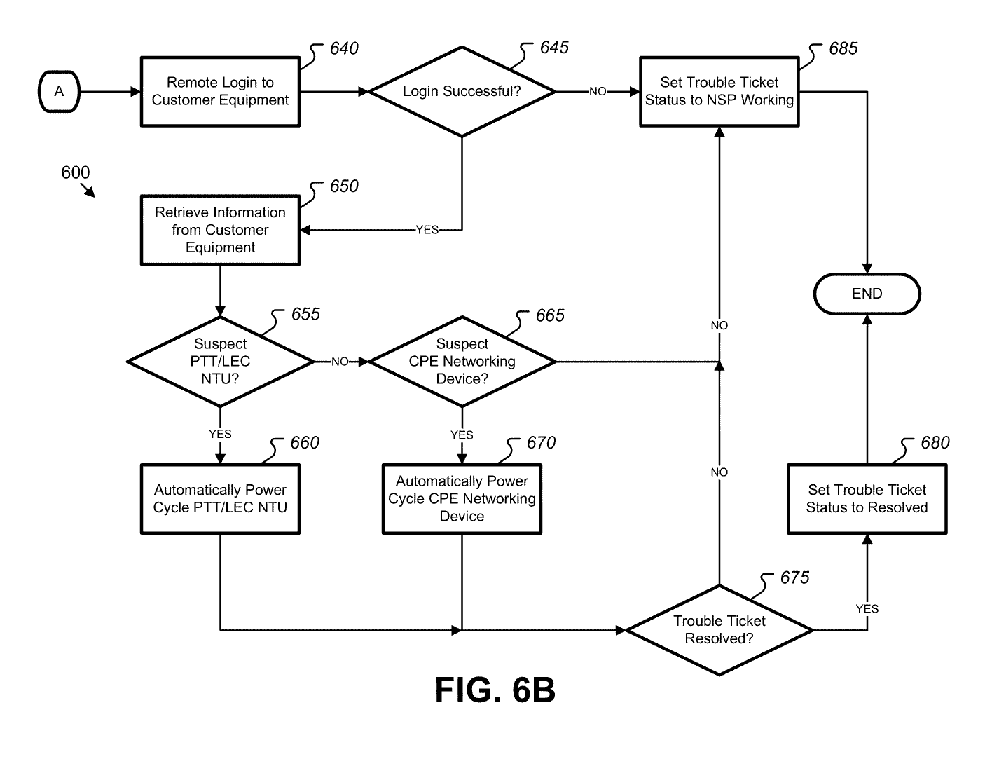

FIGS. 6A and 6B illustrate an exemplary process 600 for an automated incident management device 145 configured to monitor managed services at customer sites. The process 600 may be performed by an automated incident management device 145 configured to manage a plurality of customer sites and associated customer equipment devices. The customer equipment devices may include one or more of a MSE device 205, a MSR device 305, a MSE device 405, a CPE networking device 120, and a PTT/LEC NTU 115 at a customer site in communication with an automated incident management device 145.

In block 605, the automated incident management device 145 checks the status of customer equipment at a customer site. For example, the automated incident management device 145 may periodically send a status request message to each CPE networking device 120 or other item of customer equipment being monitored by the automated incident management device 145. In some examples, the status request message may be a ping message, while in other cases the status request message may take the form of a request for information, such as a request for aspects of the usage or configuration of the customer equipment.

In decision point 610, the automated incident management device 145 determines whether the customer equipment is down (e.g., non-operational). For example, if the CPE networking device 120 or other item of customer equipment fails to respond to a status request or is unavailable for a duration of time, the automated incident management device 145 may determine that the CPE networking device 120 is down. In some cases, the CPE networking device 120 may fail to respond because the CPE networking device 120 has locked up or lost power. If the customer equipment is down, control passes to decision point 615. Otherwise, control passes to block 605.

In decision point 615, the automated incident management device 145 determines whether an existing trouble ticket 150 exists for the customer equipment. For example, the automated incident management device 145 may query a data store of trouble ticket 150 for an identifier of the CPE networking device 120 or other item of customer equipment that is determined to be down. If an existing trouble ticket 150 exists for the customer equipment, control passes to decision point 655. Otherwise, control passes to block 605.

In block 620, the automated incident management device 145 creates a trouble ticket 150 for the customer equipment being down. For example, the automated incident management device 145 may send a command to the data store of trouble ticket 150 configured to cause the data store to create a new trouble ticket 150 associated with the identifier of the customer equipment determined to be down.

In decision point 625, the automated incident management device 145 determines whether a power down message associated with the customer equipment has been received from the customer equipment. For example, the automated incident management device 145 may query a data source to determine whether the automated incident management device 145 received a power source 135 down message from a device at the same customer site as the customer equipment. The message may include an identifier of the CPE networking device 120 or of another device at the customer site having an issue. In other cases, the message may include an identifier of the user, or of the managed services account. If a power down message associated with the customer equipment was received, control passes to block 630. Otherwise, control passes to block 640 as described in detail with respect to FIG. 6B.

In block 630, the automated incident management device 145 updates the identified trouble ticket 150 associated with the customer equipment to indicate the existence of an issue that is the responsibility of the customer. For example, the automated incident management device 145 may send an update to the data store configured to indicate that the power source 135 down message received from the customer device has been correlated with a corresponding customer equipment down determination made by the automated incident management device 145.

In block 635, the automated incident management device 145 sends a notification to the customer of the issue indicating that the issue is the responsibility of the customer, not of the provider of the managed service. After block 635, the process 600 ends.

In block 640 of FIG. 6B, the automated incident management device 145 logs into the customer equipment. For example, the automated incident management device 145 may log into a MSE device 205, a MSR device 305, or a MSE device 405 at the customer site. In some cases, the login to the customer site may be performed according to a secondary network connection 130 to the customer site, such as by way of a wireless network or a connection to the PSTN over a telephone line.

In decision point 645, the automated incident management device 145 determines whether the login was successful. For example, the login may be successful if the customer equipment could be connected to over the secondary network connection 130. However, in some cases the customer equipment may be inaccessible via the secondary network connection 130, or may be damaged or otherwise inaccessible. In such cases the login would not succeed. If the login was successful, control passes to block 650. Otherwise, control passes to block 685.

In block 650, the automated incident management device 145 retrieves information from the customer equipment. For example the automated incident management device 145 may be configured to retrieve log files or configuration information from the CPE networking device 120 or other items of customer equipment, such as a MSE device 205, a MSR device 305, or a MSE device 405 at the customer site. Advantageously, the automated incident management device 145 may retrieve the information before a user attempts to address the issue by rebooting the customer equipment, as rebooting may delete evidence of the underlying cause of the trouble ticket 150.

In decision point 655, the automated incident management device 145 determines whether the PTT/LEC NTU 115 is likely a cause of the trouble ticket 150. For example, the automated incident management device 145 may determine according to rules that specify corrective measures likely to resolve the trouble ticket 150 that, based on the retrieved information from the customer equipment, the automated incident management device 145 may determine that the PTT/LEC NTU 115 has experienced an error and may require a reboot. For instance, polling of the customer equipment or log file information retrieved from devices at the customer site may indicate that the PTT/LEC NTU 115 is no longer functioning. If the information indicates that the issue may be with the PTT/LEC NTU 115, control passes to block 660. Otherwise, control passes to decision point 665.

In block 660, the automated incident management device 145 initiates a remote power cycle of the PTT/LEC NTU 115. For example, the automated incident management device 145 may send a reboot message to a MSE device 405 at the customer site by way of the login to the customer equipment discussed above. The MSE device 405 may in turn be configured to reboot the PTT/LEC NTU 115 using a switch 215.

In decision point 665, the automated incident management device 145 determines whether the CPE networking device 120 is likely a cause of the trouble ticket 150. For example, the automated incident management device 145 may determine according to rules that specify corrective measures likely to resolve the trouble ticket 150 that, based on the retrieved information from the customer equipment, the automated incident management device 145 may determine that the CPE networking device 120 has experienced an error and may require a reboot. For instance, polling of the customer equipment or log file information retrieved from devices at the customer site may indicate that the CPE networking device 120 is no longer functioning. If the information indicates that the issue may be with the CPE networking device 120, control passes to block 670. Otherwise, control passes to decision point 685.

In block 670, the automated incident management device 145 initiates a remote power cycle of the CPE networking device 120. For example, the automated incident management device 145 may send a reboot message to a MSE device 405 at the customer site by way of the login to the customer equipment discussed above. The MSE device 405 may in turn be configured to reboot the CPE networking device 120 using a switch 215.

In decision point 675, the automated incident management device 145 determines whether the trouble ticket 150 has been resolved. For example, the automated incident management device 145 may attempt to communicate with the customer equipment, such as using the PTT/LEC NTU 115 and CPE networking device 120. If communication is established with the customer equipment, then the automated incident management device 145 may determine that the trouble ticket 150 has been resolved. If so, control passes to block 680. Otherwise, control passes to block 685.

In block 680, the automated incident management device 145 associates the trouble ticket 150 with a resolved status. After block 680, the process 600 ends.

In block 685, the automated incident management device 145 associates the trouble ticket 150 with a network service provider working status. Accordingly, because the issue indicated by the trouble ticket 150 persists, and further because the issue has been determined not to obviously be the fault of the customer, network service provider personnel may be assigned to further diagnose and address the trouble ticket 150. After block 685, the process 600 ends.

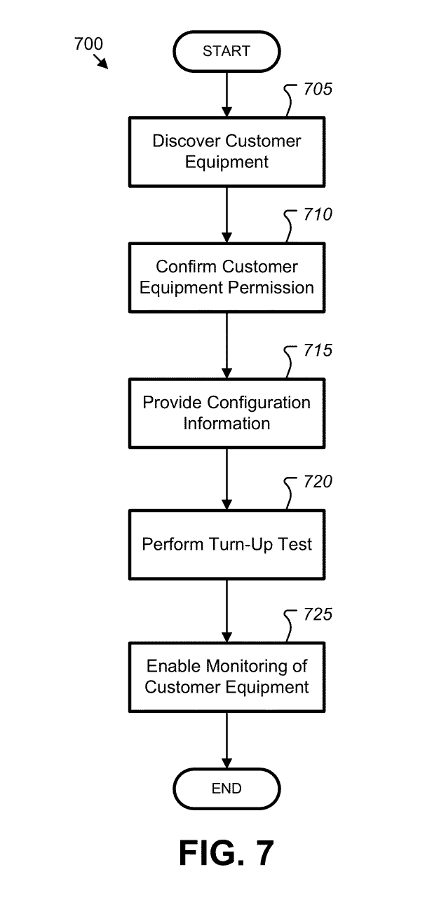

FIG. 7 illustrates an exemplary process 700 for an automated incident management device 145 configured to set up customer equipment. As with the process 600, the process 700 may be performed by an automated incident management device 145 configured to manage a plurality of customer sites and associated customer equipment devices. The customer equipment devices may include one or more of a MSE device 205, a MSR device 305, a MSE device 405, a CPE networking device 120, and a PTT/LEC NTU 115 at a customer site in communication with an automated incident management device 145.

In block 705, the automated incident management device 145 discovers the customer equipment. For example, the automated incident management device 145 may listen for requests from customer equipment sent to an address of the automated incident management device 145, or the automated incident management device 145 may periodically scan the network addresses of customer sites for the addition of devices that may respond to the scan requests.

In block 710, the automated incident management device 145 confirms permissions of the customer equipment. For example, the automated incident management device may retrieve an identifier or hardware token value from the discovered customer equipment, and may verify the network location of the customer equipment with information relating to which customer equipment should be installed at what customer sites.

In block 715, the automated incident management device 145 provides configuration information to the customer equipment. For example, the automated incident management device 145 may provide settings or other network parameters to the customer equipment. This information may be sent by way of the secondary network connection 130 for cases where the customer equipment may not be configured to receive such transmissions without being configured. For security reasons, in some examples configuration information may be alterable via the secondary network connection 130 but not by way of a primary network connection.

In block 720, the automated incident management device 145 performs turn-up testing of the customer equipment. For example, the automated incident management device 145 may initiate testing of a local access portion of a network once the configuration of the customer equipment is performed by establishing a loopback on the access circuit through the PTT/LEC network 110, which may cause a temporary loss of access to the customer equipment through the primary connection.

In block 725, the automated incident management device 145 enables monitoring of the customer equipment. Monitoring of the customer equipment may be performed, for example, using processes such as the processes 500 and 600 discussed in detail above.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system, comprising:
an automated incident management device including a processor configured to cause the automated incident management device to:
receive a message from a customer site, the message indicative of a customer issue with a managed service provided to the customer site by way of a primary network connection;
connect to an item of customer equipment by way of a secondary network connection to the customer site;
retrieve information from the customer equipment by way of the secondary network connection;
attempt a corrective measure with the managed service based on the retrieved information, the corrective measure being determined according to rules that specify corrective measures likely to resolve the trouble ticket; and
update a trouble ticket associated with the customer site responsive to the attempted corrective measure.

2. The system of claim 1, wherein the automated incident management device is further configured to:
periodically check a status of the item of customer equipment at the customer site;
determine whether the item of customer equipment is experiencing an issue;
correlate the experiencing of the issue with a report of the issue received from the customer site; and
create the trouble ticket associated with the customer site when both the automated incident management device and the customer site indicate the issue at the customer site.

3. The system of claim 1, wherein the automated incident management device is further configured to:
determine whether a power source down message was received from the customer site; and
update the trouble ticket to indicate that the trouble ticket is the result of an issue with the managed service that is a responsibility of the customer to address.

4. The system of claim 3, wherein the automated incident management device is further configured to send a message to the customer indicating that the issue with the managed service is the responsibility of the customer to address.

5. The system of claim 1, wherein the automated incident management device is further configured to:
discover the item of customer equipment;
provide configuration information to the item of customer equipment by way of the secondary network connection;
perform testing to confirm the functioning of the item of customer equipment; and
enable monitoring of the tested item of customer equipment.

6. The system of claim 1, wherein the automated incident management device is further configured to initiate a backup of data at the customer site by way of the secondary network connection responsive to the message indicative of the customer issue with the managed service.

7. (canceled)

8. The system of claim 1, wherein the rules specify a corrective measure including at least one of rebooting the item of equipment and rebooting an item of equipment related to the item of equipment.

9. A method, comprising:
receiving a message from a customer site, the message indicative of a customer issue with a managed service provided to the customer site by way of a primary network connection;
connecting to an item of customer equipment by way of a secondary network connection to the customer site;
retrieving information from the customer equipment by way of the secondary network connection;
attempting a corrective measure with the managed service based on the retrieved information, the corrective measure being determined according to rules that specify corrective measures likely to resolve the trouble ticket; and
updating a trouble ticket associated with the customer site responsive to the attempted corrective measure.

10. The method of claim 9, further comprising:
periodically checking a status of the item of customer equipment at the customer site;
determining whether the item of customer equipment is experiencing an issue;
correlating the experiencing of the issue with a report of the issue received from the customer site; and
creating the trouble ticket associated with the customer site when both the automated incident management device and the customer site indicate the issue at the customer site.

11. The method of claim 9, wherein the automated incident management device is further configured to:
determining whether a power source down message was received from the customer site; and
updating the trouble ticket to indicate that the trouble ticket is the result of an issue with the managed service that is a responsibly of the customer to address.

12. The method of claim 11, further comprising sending a message to the customer indicating that the issue with the managed service is the responsibility of the customer to address.

13. The method of claim 9, further comprising:
discovering the item of customer equipment;
providing configuration information to the item of customer equipment by way of the secondary network connection;
performing testing to confirm the functioning of the item of customer equipment; and
enabling monitoring of the tested item of customer equipment.

14. The method of claim 9, further comprising initiating a backup of data at the customer site by way of the secondary network connection responsive to the message indicative of the customer issue with the managed service.

15. The method of claim 9, further comprising setting configuration aspects of the item of customer equipment by way of the secondary network connection.

16. (canceled)

17. A non-transitory computer readable medium storing an application software program, the application being executable by an automated incident management device to provide operations comprising:
receiving a message from a customer site, the message indicative of a customer issue with a managed service provided to the customer site by way of a primary network connection;
connecting to an item of customer equipment by way of a secondary network connection to the customer site;
retrieving information from the customer equipment by way of the secondary network connection;
attempting a corrective measure with the managed service based on the retrieved information, the corrective measure being determined according to rules that specify corrective measures likely to resolve the trouble ticket; and
updating a trouble ticket associated with the customer site responsive to the attempted corrective measure.

18. The non-transitory computer readable medium of claim 17, further providing for operations comprising:
periodically checking a status of the item of customer equipment at the customer site;
determining whether the item of customer equipment is experiencing an issue;
correlating the experiencing of the issue with a report of the issue received from the customer site; and
creating the trouble ticket associated with the customer site when both the automated incident management device and the customer site indicate the issue at the customer site.

19. The non-transitory computer readable medium of claim 17, further providing for operations comprising:
determining whether a power source down message was received from the customer site; and
updating the trouble ticket to indicate that the trouble ticket is the result of an issue with the managed service that is a responsibly of the customer to address.

20. (canceled)

21. The non-transitory computer readable medium of claim 17, further providing for operations comprising:
discovering the item of customer equipment;
providing configuration information to the item of customer equipment by way of the secondary network connection;
performing testing to confirm the functioning of the item of customer equipment; and
enabling monitoring of the tested item of customer equipment.

22. (canceled)

23. The non-transitory computer readable medium of claim 17, further providing for operations comprising setting configuration aspects of the item of customer equipment by way of the secondary network connection.

24. The non-transitory computer readable medium of claim 17, further providing for operations comprising the rules specifying a corrective measure including at least one of rebooting the item of equipment and rebooting an item of equipment related to the item of equipment.

25. The system of claim 1, wherein the secondary network connection connects to a network that includes at least one of a public switched telephone network (PTSN) link and a wireless connection over a cellular data network.

26. The system of claim 8, wherein the item of equipment is plugged into an uninterruptible power supply and the rebooting of the item of equipment uses the uninterruptible power supply.

27. The system of claim 1, wherein the message from the customer site sent by an uninterruptible power supply in response to a loss of power at the customer site as detected by the uninterruptible power supply.

28. The system of claim 27, wherein the uninterruptible power supply powers the primary network connection while the power is down at the customer site.
